(19) United States
(12) Patent Application Publication
(10) Pub. No.: US 2021/0173885 A1
(43) Pub. Date: Jun. 10, 2021

(54) SYSTEM AND METHOD FOR PROCESSING DIGITAL DATA SIGNALS

(71) Applicant: Antitoxin Technologies Inc., Palo Alto, CA (US)

(72) Inventors: Zohar Levkovitz, Palo Alto, CA (US); Ron Porat, Tel-Mond (IL); Hemi Pecker, Haifa (IL); Doron Habshush, Tel-Aviv (IL); Arik Cohen, Jerusalem (IL)

(73) Assignee: Antitoxin Technologies Inc., Palo Alto, CA (US)

(21) Appl. No.: 16/702,695

(22) Filed: Dec. 4, 2019

(51) Int. Cl. G06F 16/9536; G06N 20/00; G06K 9/00; G06F 40/35

(52) U.S. Cl. CPC G06F 16/9536; G06F 40/35; G06K 9/00684; G06N 20/00

(57) ABSTRACT

A system for processing digital data signals, comprising at least one hardware processor adapted to identifying an offending social interaction by: in at least one of a plurality of iterations: receiving a signal from a first other hardware processor, where the signal is generated according to an action of a first person, has a plurality of signal attributes, and is associated with a plurality of entities comprising a first entity and a second entity, each entity having a plurality of entity confidence values of a plurality of entity attributes; identifying at least one correlation between the signal and at least one other signal received from at least one second other hardware processor in at least one other of the plurality of iterations, the at least one other signal generated according to at least one other action of at least one second person and associated with another plurality of entities comprising.

### FIELD AND BACKGROUND OF THE INVENTION

The present invention, in some embodiments thereof, relates to processing digital data signals and, more specifically, but not exclusively, to processing digital data signals for the purpose of identifying offending social interactions.

These days there is an increasing use of digital technologies for social interaction. Digital technologies used for social interactions encompass a wide range of areas including digital communication networks, social network services, for example Facebook, Instagram, Snapchat, and Twitter, messaging services, for example WhatsApp, gaming platforms, for example Fortnite, online communities (forums), blogs, and file sharing, for example via a web site. Some social interactions using digital technologies include sharing, distributing and exchanging digital content, for example digital images, digital video and digital audio. Some social interactions using digital technologies include exchanging text messages.

Some social interactions using digital technologies have allowed creating communities where individuals participating in a community interact in a manner that is supportive of the community. For example, a WhatsApp group allowing a group of friends to communicate, and a forum supporting bereaving individuals. However, as use of digital technologies for social interaction has increased, so has increased the use of digital technologies for offending social interactions. Digital technologies are known to be used by some people to make other people feel angry, sad, or scared. In addition, digital technologies are known to be used to perpetrate socially unacceptable, and occasionally illegal, behavior, for example racism, offering an illegal substance such as alcohol or an identified drug, offering gambling, solicitation, pornography and pedophilia.

Digital-technology-enabled social interactions involving children are also increasing in prevalence. For example, some children interact with their peers using social media platforms, for example WhatsApp groups. Other examples of social interactions involving children include a child playing network connected games, for example Fortnite, a child accessing an online community, and a child browsing one or more web sites on the Internet. As a result, there is an increase in an amount of children adversely effected by social interactions, for example by being bullied using digital technologies, or by having an interaction with a sexual predator via digital technologies. In addition, some children use digital technology to share an intention to inflict self-harm or to confess substance abuse, for example in a chat group or on a social media personal page.

There is an increasing amount of evidence linking exposure of a child to offending social interactions to an increase in a likelihood of the child to engage in self-harm and a likelihood of the child to attempt suicide. In addition, there is an increasing amount of evidence linking exposure of a child to offending social interactions to an increase in long term effects including a likelihood of the child to engage in substance abuse, a likelihood of the child to commit non-violent crime, reduced physical safety of the child at school, and a reduction in the child's motivation to apply themselves to school work and extracurricular activity.

There is a need to identify offending social interactions on digital technology based platforms, to reduce an amount of adverse effects of such offending social interactions.

### SUMMARY OF THE INVENTION

It is an object of the present invention to provide a system and a method for identifying in digital data signals offending social interactions.

The foregoing and other objects are achieved by the features of the independent claims. Further implementation forms are apparent from the dependent claims, the description and the figures.

According to a first aspect of the invention, a system for processing digital data signals comprises at least one hardware processor adapted to identifying an offending social interaction by: in at least one of a plurality of iterations: receiving a signal from a first other hardware processor, where the signal is generated according to an action of a first person, has a plurality of signal attributes, and is associated with a plurality of entities comprising a first entity and a second entity, each entity having a plurality of entity confidence values of a plurality of entity attributes; identifying at least one correlation between the signal and at least one other signal received from at least one second other hardware processor in at least one other of the plurality of iterations, the at least one other signal generated according to at least one other action of at least one second person and associated with another plurality of entities comprising the first entity; and updating at least one entity confidence value of the second entity subject to identifying the at least one correlation; identifying at least one offending social interaction by identifying for at least one entity of the plurality of entities at least one other entity confidence value exceeding a threshold entity confidence value; and providing an indication of the at least one offending social interaction to at least one management software object executed by the at least one hardware processor for the purpose of performing at least one management task.

According to a second aspect of the invention, a method for processing digital data signals comprises identifying an offending social interaction by: in at least one of a plurality of iterations: receiving a signal from a first other hardware processor, where the signal is generated according to an action of a first person, has a plurality of signal attributes, and is associated with a plurality of entities comprising a first entity and a second entity, each entity having a plurality of entity confidence values of a plurality of entity attributes; identifying at least one correlation between the signal and at least one other signal received from at least one second other hardware processor in at least one other of the plurality of iterations, the at least one other signal generated according to at least one other action of at least one second person and associated with another plurality of entities comprising the first entity; and updating at least one entity confidence value of the second entity subject to identifying the at least one correlation; identifying at least one offending social interaction by identifying for at least one entity of the plurality of entities at least one other entity confidence value exceeding a threshold entity confidence value; and providing an indication of the at least one offending social interaction to at least one management software object executed by the at least one hardware processor for the purpose of performing at least one management task.

According to a third aspect of the invention, a system for identifying a suspected pedophile comprises at least one hardware processor adapted for: in at least one of a plurality of iterations: receiving a signal from a first other hardware processor, where the signal is generated according to an action of a first person, has a plurality of signal attributes, and is associated with a plurality of entities comprising a first entity and a second entity, each entity having a plurality of entity confidence values of a plurality of entity attributes; identifying at least one correlation between the signal and at least one other signal received from at least one second other hardware processor in at least one other of the plurality of iterations, the at least one other signal generated according to at least one other action of at least one second person and associated with another plurality of entities comprising the first entity; and updating at least one entity confidence value of the second entity subject to identifying the at least one correlation; identifying at least one pedophilic interaction by identifying for at least one entity of the plurality of entities at least one other entity confidence value exceeding a threshold entity confidence value; and providing an indication of the at least one offending social interaction to at least one management software object executed by the at least one hardware processor for the purpose of performing at least one management task.

With reference to the first and second aspects, in a first possible implementation of the first and second aspects of the present invention the plurality of entity confidence values are computed according to at least one classification output of at least one classifier in response to the signal. Computing the plurality of confidence values according to at least one classification output of at least one classifier increases accuracy of an entity confidence value and thus increases accuracy of an identification of at least one offending social interaction according thereto.

With reference to the first and second aspects, in a second possible implementation of the first and second aspects of the present invention identifying the at least one correlation comprises inputting the signal and the at least one other signal into at least one model. Optionally updating the at least one entity confidence value of the second entity is according to an output of the at least one model in response to input comprising the signal and the at least one other signal. Optionally, the at least one model is selected from a group of models consisting of: a neural network, a machine learning statistical model, an analytical model, and a hybrid machine learning analytical model. Inputting the signal and the at least one other signal into at least one model increases accuracy of identifying the at least one correlation, thus updating the at least one entity confidence value according to the output of the at least one model increases accuracy of at least one entity confidence value, increasing accuracy of identification of the at least one offending social interaction.

With reference to the first and second aspects, in a third possible implementation of the first and second aspects of the present invention the signal is selected from a group of signals consisting of: a digital video, an image, an image extracted from a video, a text extracted from a video, an audio signal extracted from a video, a text, a captured audio signal, a user location, a user action, and a universal resource location (URL) value. Optionally, the user action is selected from a group of events consisting of: video uploaded, video watched, video deleted, audio uploaded, user added to chat, and user removed from chat. Optionally, the signal is a digital video. Optionally, identifying the offending social interaction further comprises extracting a plurality of video frames from the digital video, and using at least one of the plurality of video frames as the signal.

With reference to the first and second aspects, in a fourth possible implementation of the first and second aspects of the present invention at least one of the plurality of signal attributes is selected from a group of signal attributes consisting of: a user identifier, a signal identifier, an original signal identifier, a chat framework identifier, a chat identifier, a time, an amount of time, a channel identifier, a geographical location, defamation detected, profanity detected, nudity detected, sexual content detected, sexual intention detected, self-harm intention detected, illegal-substance trafficking detected, solicitation detected, insult detected, hunter detected, predator detected, a detected object, a sentiment, person detected, a gender, an age range, a language, a geographic location, a location classification, an amount of associations with a chat, an amount of associations with a location, an amount of warning, a pedophilia score, an aggression score, a real-life invitation, a threat, a grooming score, a reputation, a personal insult score, a racism score, a shaming score, a bullying score, and an offensiveness score. Optionally, at least one of the plurality of entity attributes is selected from a group of attributes consisting of: a pedophilia score, an aggression score, a detection score, a reputation, an aggregation score, a hunter score, a predator score, a grooming score, an insult score, a shaming score, and a racism score.

With reference to the first and second aspects, in a fifth possible implementation of the first and second aspects of the present invention identifying the offending social interaction further comprises associating the other signal with the second entity. Optionally, the indication of the at least one offending social interaction comprises at least one reference to at least one signal associated with the at least one entity. Associating the other signal with the second entity facilitates validating the accuracy of the identification of the at least one offending social interaction, increasing reliability and usability of a system implemented according to the present invention.

With reference to the first and second aspects, in a sixth possible implementation of the first and second aspects of the present invention identifying the at least one correlation comprises identifying at least one rule of a plurality of rules, the rule having a condition part and an action part, according to a match test applied to the condition part of the at least one rule, a first plurality of confidence values computed for the plurality of signal attributes of the signal, and a second plurality of confidence values computed for at least one other plurality of signal attributes of the at least one other signal. Optionally, updating the at least one entity confidence value of the second entity is according to the action part of the at least one rule. Optionally, the match test is further applied to at least one additional plurality of confidence values, computed for the plurality of attributes of at least one additional signal, where each of the at least one additional signal is received from one of a plurality of other hardware processor, generated according to at least one additional action of at least one additional person, and is associated with at least one additional plurality of entities each comprising the first entity. Optionally, identifying the offending social interaction further comprises associating the at least one rule with the second entity. Optionally, the indication of the at least one offending social interaction comprises at least one reference to at least one rule associated with the at least one entity. Using at least one rule to identify the at least one correlation and to update the at least one entity confidence value facilitates tuning the at least one entity confidence value according to one or more identified relationships between a plurality of identified indicators of offending behavior, thus increasing accuracy of an identification of an offending social interaction. Associating the at least one rule with the second entity facilitates validating the accuracy of the identification of the at least one offending social interaction, increasing reliability and usability of a system implemented according to the present invention.

With reference to the first and second aspects, in a seventh possible implementation of the first and second aspects of the present invention identifying the offending social interaction further comprises: in each of a plurality of periodic iterations: selecting a first historical signal and a second historical signal of a plurality of signals received in the plurality of iterations, the first historical signal associated with a first plurality of entities comprising the first entity and the second entity and the second historical signal associated with a second plurality of entities comprising the first entity; identifying at least one other correlation between the first historical signal and the second historical signal; and updating at least one other entity confidence value of the second entity subject to identifying the at least one other correlation. Periodically identifying the at least one correlation, and additionally or alternatively periodically identifying the at least one offending social interaction, facilitates reducing an amount of computation compared to identifying the at least one correlation, and additionally or alternatively periodically identifying the at least one offending social interaction, when every new signal that is received, thus reducing cost of operation of a system implemented according to the present invention.

With reference to the first and second aspects, in an eighth possible implementation of the first and second aspects of the present invention the at least one hardware processor is further adapted to: computing a plurality of normalized confidence values in an identified range of confidence values using the plurality of entity confidence values of at least some of the plurality of entities, and using the plurality of normalized confidence values when identifying the at least one offending social interaction. Using a plurality of normalized confidence values facilitates distinguishing between an indication of extreme offensive behavior and an indication of an unpleasant situation.

With reference to the first and second aspects, in a ninth possible implementation of the first and second aspects of the present invention the at least one hardware processor is connected to the first other hardware processor via at least one digital communication network interface. Connecting using at least one digital communication network interface facilitates receiving one or more signals from one or more other hardware processors located remote to a location of the at least one hardware processor, increasing amount and variety of signals used to identify the at least one offending social interaction which in turn increases accuracy of identification of the at least one offending social interaction by increasing a likelihood of identifying the at least one offending social interaction.

With reference to the first and second aspects, in a tenth possible implementation of the first and second aspects of the present invention the at least one hardware processor is the first other hardware processor.

With reference to the first and second aspects, in an eleventh possible implementation of the first and second aspects of the present invention the at least one hardware processor is further adapted to updating at least one other entity confidence value of at least one of the other plurality of entities subject to identifying the at least one correlation. Optionally, the second entity is the first entity.

With reference to the first and second aspects, in a twelfth possible implementation of the first and second aspects of the present invention performing the at least one management task comprises at least one of: instructing at least one other hardware processor, connected to the at least one hardware processor, to decline sending one or more other additional signals associated with the at least one entity; instructing at least one additional other hardware processor, connected to the at least one hardware processor, to generate an alarm perceivable by a person monitoring an output of the at least one additional other hardware processor; sending a message to the at least one other hardware processor; storing the indication on at least one non-volatile digital storage connected to the at least one hardware processor; and displaying another message on one or more display devices connected to the at least one hardware processor. Instructing the at least one other hardware processor to decline sending one or more other additional signals associated with the at least one entity facilitates terminating the at least one offending social interaction, increasing usability of the system. Instructing the at least one additional other hardware processor to generate an alarm perceivable by a person facilitates a human intervention to protect a user and additionally or alternatively to terminate the at least one offending social interaction, increasing usability of the system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration likening identification of an offending social interaction to a jigsaw puzzle;

FIG. 2 is another schematic illustration likening identification of the offending social interaction to a jigsaw puzzle;

FIG. 3 is a schematic block diagram of an exemplary system, according to some embodiments of the present invention;

FIG. 4 is a schematic block diagram of an exemplary flow of data, according to some embodiments of the present invention;

FIG. 5 is a flowchart schematically representing an optional flow of operations for identifying an offending social interaction, according to some embodiments of the present invention;

FIG. 6 is a flowchart schematically representing an optional flow of operations for identifying an offending social interaction using a rule, according to some embodiments of the present invention;

FIG. 7 is a flowchart schematically representing another optional flow of operations for identifying an offending social interaction, according to some embodiments of the present invention;

FIG. 8 is a flowchart schematically representing an optional flow of operations for periodic processing, according to some embodiments of the present invention; and

FIG. 9 is a flowchart schematically representing optional flow of operations for identifying a pedophile, according to some embodiments of the present invention.

### DESCRIPTION OF SPECIFIC EMBODIMENTS OF THE INVENTION

The present invention, in some embodiments thereof, relates to processing digital data signals and, more specifically, but not exclusively, to processing digital data signals for the purpose of identifying offending social interactions.

As used herein, the term “toxic behavior” refers to behavior of one or more people for the purpose of causing harm to one or more other people's physical health and additionally or alternatively emotional well-being.

The following description focuses on offending behavior targeted at children, however the present invention is not limited to detecting offending behavior targeted at children and may be applied to detecting offending behavior targeted at other targets, for example women, members of a social minority, or any individual target.

Additionally, for brevity, the term “digital platform” is henceforth used to mean any platform based on digital technology, including but not limited to digital communication networks, social network services, messaging services, gaming platforms, online communities (forums), blogs, file sharing sites, and web sites.

Toxic behavior manifests in myriad forms. Toxic behavior may be hateful, without additional qualifiers. Toxic behavior may reflect a prejudice, some examples being a gender based prejudice, a prejudice against a sexual orientation, and racism. Some toxic behavior is personal, for example one or more people being offensive towards another person based on an event in a shared personal history. Some toxic behavior is general, based on a person's association with an identified group, for example racism towards people of color. Some toxic behavior includes grooming, that is a person establishing an emotional connection with another person for the purpose of furthering exploitation of the other person, for example engaging the other person in prostitution, engaging the other person in pornography, and sexually abusing the other person. Some examples of toxic behavior are: sharing a pornographic image, sharing a pornographic video, sexual solicitation, an exchange having a sexual nature (sexting), requesting pictures, requesting videos, solicitation to abuse a substance, solicitation to deal in a controlled substance, and sending an offending message. A non-limiting list of examples of offending messages includes: a racist expression, profanity, defamation, humiliation, an expression of hate, a request to meet in real life (MIRL), and an insult. Toxic behavior may be identified by a response of a target, for example an expression of being insulted, angered or scared. Toxic behavior may comprise bullying, that is behavior seeking to harm, intimidate or coerce a target person or persons. Toxic behavior may involve shaming, that is publication of private information with the intention to cause embarrassment or humiliation.

Social interactions on digital platforms comprise generation of a plurality of digital signals, each generated according to an action of one or more persons. For example, when a person uploads a video, a digital video is generated on the platform. In another example, a person sending a message in a chat group results in generating a digital signal comprising the message. In another example an application executing on a person's device, for example a person's smartphone, periodically generates a signal indicative of the person's location and sends the signal to another hardware processor, for example a platform server. In another example, when a user accesses a universal resource location (URL) via a browser the browser may record the URL. Other examples of user actions include watching a video, deleting a video, uploading an audio, adding a user to a chat and removing a user from a chat. Other examples of a signal include an image, an image extracted from a video, an audio extracted from a video, a text, a text extracted from subtitles of a video, a captured audio signal, and a user action. Some signals are generated by a hardware processor, executing an application. For example, a mobile phone executing a client application of a social media platform. Another example is a computer executing a network connected game, connected to a gaming platform server.

There exist methods for detection of some aspects of toxic behavior. For example, there exist methods of detecting nudity in an image or a video. In addition, there exist methods for detecting a sentiment in a text, in a facial expression, and in an audio signal. Such methods analyze a signal, generated according to an action of a person, to detect an indication of toxic behavior in the signal. Some such methods compute for a signal one or more classifications, and associate each computed classification with a confidence value indicative of a likelihood of the classification. For example, a method for identifying nudity in an image may classify an image as containing nudity at an identified confidence value, for example a confidence value indicative of a 90% likelihood the image contains nudity. Such methods analyze each signal separately, and compute each classification independently of other classifications.

However, a nature of a social interaction may be derived from a combination of features detected in a signal. Moreover, an impact that a feature detected in a signal has on a deduction made regarding a social interaction may be increased by other features detected in the signal. For example, when nudity is detected in an image and a child is identified in an image, a likelihood of the image being related to child abuse increases (even when the child themselves is not nude). In another example, a request to meet in real life may not in itself indicate an offending social interaction, for example when the request is sent from an adult to another adult. However, when a target of such a request is identified as being a child, a request to meet in real life increases a likelihood that this request is part of an offending social interaction.

It may be the case that in analyzing a digital signal it is possible to identify sufficient features to correctly identify an offending social interaction. For example, there exist methods to identify a naked child in a digital image. However, there are many cases where a plurality of features that combine to identify a social interaction as offending cannot be detected in a single signal. For example, in an ongoing conversation between two people, one message may comprise a first person revealing their age indicating they are a child. Another message, sometime after, may comprise an invitation from the second person to the first person to meet in real life. Existing methods that analyze signals separately cannot identify that the invitation in the other message is offending. In another example, in a chat group such as a WhatsApp group, a person may send a message to the chat group expressing a sentiment of being offended or scared. As the message is sent to a group, analyzing just the message does not reveal what other messages the person is responding to or who sent the other messages. As a result, existing methods that analyze single signals may fail to identify an offending social interaction, and additionally or alternatively may fail to identify a perpetrator of offensive (toxic) behavior.

To increase accuracy of identifying an offending social interaction, the present invention proposes, in some embodiments thereof, updating one or more confidence values of an entity according to one or more correlations between two or more signals. An entity may be a person associated with a signal. Other examples of an entity are a chat and an application. In such embodiments, the present invention proposes identifying one or more correlations between two or more signals, and updating one or more confidence values of one or more entities associated with one of the two or more signals according to the identified one or more correlations. For example, a first signal may be an image sent by a first person in a first chat. The image may be identified as having pedophilic content, that is the image has a first signal attribute indicative of pedophilic content associated with a first confidence score. Further in this example, a second signal may comprise a textual solicitation invitation sent by the first person in a second chat. Identifying a correlation between the first signal and the second signal, as both signals are associated with the first person, allows increasing a score of the second chat indicative of the second chat being toxic, beyond another score assigned to the second chat only as a result of identifying the textual solicitation invitation in the second signal. Further, the present invention proposes in such embodiments identifying one or more offending social interactions by identifying for at least one entity of the one or more entities at least one entity confidence value exceeding a threshold entity confidence value.

According to some embodiments of the present invention, each signal of the two or more signals has a plurality of signal attributes. Some of the plurality of signal attributes are indicative of features detected in the respective signal, for example a user identifier, a signal identifier, an original signal identifier, a chat framework identifier, a time, an amount of time, a defamation detected indication, a profanity detected indication, and a sexual intention detected. Some other of the plurality of signal attributes are indicative of a deduction computed regarding the respective signal, for example a personal insult score, a racism score, and a bullying score.

Optionally, each signal of the two or more signals is associated with a plurality of entities. For example, a signal may be associated with a person performing an action that resulted in generation of the signal. In another example, a signal is associated with a target of the action, or a target of the signal, for example another person. Other examples of an entity associated with a signal include an originating signal, for example when the signal is extracted from the originating signal such as an image extracted from a video, a chat identifier, and a channel identifier, for example an application identifier.

Optionally, each entity has a plurality of entity attributes, each indicative of a deduction computed regarding the respective entity. Some examples of an entity attribute are a pedophilia score, an aggression score, a reputation, a hunter score, and an aggregation score. An aggregation score is indicative of an aggregation of one or more other entity attributes, for example a predator score is an aggregation score indicative of an aggregation of a pedophilia score and a hunter score. Optionally, each of the plurality of entity attributes is associated with a confidence score, indicative of a likelihood of the entity attribute.

The present invention proposes, in some embodiments thereof, receiving in at least one of a plurality of iterations a signal, where the signal has a plurality of signal attributes and is associated with a plurality of entities, each of the plurality of entities having a plurality of entity attributes. Optionally, each of the plurality of entity attributes has an entity confidence value. Optionally, the signal is generated according to an action of a first person. Optionally, the signal is received from a first other hardware processor, for example a mobile device executing an application. Other examples of a hardware processor are a desktop computer, a laptop computer, a server, and a tablet. Optionally, the plurality of entities of the signal comprises a first entity and a second entity, for example a person sending a message and a chat in which the message was sent. The present invention proposes in such embodiments identifying one or more correlations between the signal and at least one other signal received from a second other hardware processor. Optionally the at least one other signal is received in at least one other of the plurality of iterations.

Optionally, the at least one other signal is generated according to at least one other action of at least one second person. Optionally, the at least one other signal is associated with another plurality of entities. Optionally, the other plurality of entities comprises the first entity. Optionally, the one or more correlations are identified according to the first entity. The present invention further proposes in such embodiments updating one or more entity confidence values of the second entity, subject to identifying the one or more correlations. Further, in such embodiments the present invention proposes identifying one or more offending social interactions by identifying for at least one entity of the plurality of entities at least one other entity confidence value exceeding a threshold entity confidence value and outputting an indication of the one or more offending social interactions. Optionally, outputting the indication comprises providing the indication to one or more management software objects, executed by the one or more hardware processors, for the purpose of performing one or more management tasks.

A possible example of a management task is instructing at least one more hardware processors to decline sending one or more other additional signals associated with the at least one entity, for example to prevent a person from posting on a discussion group or to prevent a person from uploading new content to a file sharing website. Another example of a management task is instructing one or more additional hardware processors to generate an alarm perceivable by a person monitoring an output of the at least one additional other hardware processor, for example generating an alert on a mobile phone of a child's parent. Optionally, the alarm comprises an audio signal, for example a beeping sound. Optionally, the alarm comprises a visual signal, for example a message displayed on a screen and additionally or alternatively a flashing light.

Optionally, receiving the signal, identifying the one or more correlations, updating the one or more entity confidence values, identifying the one or more offending social interactions, and providing the indication are performed by one or more hardware processors adapted thereto. Identifying one or more correlations between the signal and at least one other signal allows the one or more other signals to contribute towards one or more scores of one or more entities associated with the signal, but not necessarily associated with the one or more other signals, thus increasing accuracy of an identification of an offending social interaction.

In addition, according to some embodiments of the present invention the plurality of signal attribute values of the signal are computed by one or more classifiers in response to the signal, where each of the one or more classifiers is trained to identify one or more indicators of offending behavior in an input signal. Some examples of a classifier are a neural network and a machine learning statistical model. Optionally, some of the one or more classifiers are each trained to identify one or more indicators associated with one category of offending behavior. For example, some classifiers may be trained to identify one or more indicators of bullying, for example one or more of: personal targeting identification, cynicism identification, offensive text identification, aggression identification, threat identification, and a reputation.

Optionally, each classifier is trained to identify only one indicator of offending behavior. Some other classifiers may be trained to identify one or more indicators of racism, yet some other classifiers may be trained to identify one or more indicators of predatory behavior, and yet some other classifiers may be trained to identify one or more indicators of self-harm or substance abuse.

Using one or more classifiers to compute the plurality of signal attributes increases accuracy of the signal attributes, thus increases accuracy of identifying an offending social interaction using the signal attributes. In addition, using a classifier trained to identify only one indicator of offending behavior or a small amount of indicators of offending behavior reduces processing complexity, allowing executing the classifier on lower-cost processing circuitry compared to executing a classifier trained to classify a larger amount of indicators of offending behavior. In addition, training a plurality of classifiers, each trained to identify only one of a plurality of indicators of offending behavior is faster than training one multi-class classifier to identify the plurality of indicators of offending behavior and requires fewer computing resources, reducing cost of development of a system. In addition, an output of a classifier trained to identify only one of the plurality of indicators of offending behavior is more accurate than an output of a multi-class classifier trained to identify the plurality of indicators of offending behavior, thus using a plurality of classifiers, each trained to identify only one of the plurality of indicators of offending behavior increases accuracy of an output of the system compared to using one multi-class classifier trained to identify the plurality of indicators of offending behavior.

Optionally, the plurality of entity confidence values is computed according to one or more classification outputs of the one or more classifiers in response to the signal. Optionally, at least one of the plurality of entity confidence values is computed according to one or more signal attributes of the signal, without correlation with one or more other signals. Optionally, at least some of the plurality of entity confidence values are computed by one or more other classifiers, trained to compute at least one entity confidence value in response to a plurality of signal attributes. For example, a classifier may be trained to compute an entity confidence value indicative of a likelihood of predatory behavior according to a plurality of signal attributes comprising one or more of: aggression identification, sexual content identification, grooming identification, sexual intention identification, identification of an invitation to meet in real life, and an identification of setting a location. Computing an entity confidence value according to one or more signal attributes computed using one or more classifiers increases accuracy of the entity confidence value, thus increasing accuracy of identification of an offending social interaction using the entity confidence value.

Optionally, the one or more correlations are identified using one or more models. Some examples of a model are a neural network, a machine learning statistical model, an analytical model and a hybrid machine learning analytical model. Optionally, identifying the one or more correlations comprises inputting the signal and the at least one other signal into the one or more models. Optionally, the one or more entity confidence values of the second entity are updated according to an output of the one or more models in response to the signal and the at least one other signal. Optionally, the one or more models are trained to identify one or more correlations between one or more input signals. Using one or more models trained to identify one or more correlations facilitates identifying implicit correlations between the signal and the at least one other signal, increasing accuracy of the one or more entity confidence scores, thus increasing accuracy of identifying the one or more offending social interactions.

As used herein, the term rule refers to a statement having a condition part and an action part. When using one or more rules to process data, when the data matches the condition part of a rule, according to a match test applied to the condition part of the rule, one or more operations are executed according to the action part of the rule. Optionally, identifying the one or more correlations and updating the one or more entity confidence values of the second entity are done using a plurality of rules, such that an action part of a rule is used to update one or more entity confidence values subject to identifying a match between the condition part of the rule and a plurality of confidence values computed for the signal and the at least one other signal.

For example, a rule may have a condition part:

### WHEN:

(Signal1.User.UserId IS EQUAL Signal2.User.UserId) AND

Signal1.ChildNudity >=1.0 AND

Signal2.Grooming >=1.0

where:

Signal1.User depicts a first entity associated with a first signal,

Signal2.User depicts a second entity associated with a second signal,

UserId depicts an identifier of an entity,

Signal2.ChildNudity depict a first confidence level of a first signal attribute indicative of child nudity identified in the first signal,

Signal2.User depicts a second entity associated with a second signal, and

Signal2.Grooming depicts a second confidence level of a second signal attribute indicative of grooming identified in the second signal.

Such a rule may be used to identify a user as a predator when the user is associated both with one signal having child nudity and another signal having grooming. Thus, such a rule may have an action part:

### DO:

Increase User.Predator by 0.7

where User.Predator depicts an entity confidence value of an entity attribute indicative of a likelihood of the user being a predator.

Using one or more rules to identify the one or more correlations and to update the one or more entity confidence values allows tuning the one or more entity confidence values according to one or more identified relationships between a plurality of identified indicators of offending behavior, thus increasing accuracy of an identification of an offending social interaction.

Optionally, a rule is associated with one signal. Optionally, a rule is associated with two signals. Optionally, a rule is associated with more than two signals.

In addition, the present invention proposes in some embodiments thereof saving evidence leading to the identification of the one or more offending social interactions. Optionally, saving evidence comprises associating the at least one other signal with the second entity. Optionally, the at least one other signal is associated with the second entity before identifying the one or more correlations, however it may be that the signal and the at least one other signal have only the first entity in common. As according to some embodiments of the present invention one or more entity confidence values of the second entity are updated subject to the one or more correlations between the signal and the at least one other signal, associating the at least one other signal with the second entity facilitates validating the accuracy of the identification of the one or more offending social interactions, increasing reliability and usability of a system implemented according to the present invention.

When the one or more correlations are identified according to a rule, optionally saving evidence comprises associating the rule with the second entity. Associating the rule with the second entity facilitates validating the accuracy of the identification of the one or more offending social interactions, increasing reliability and usability of a system implemented according to the present invention.

Optionally, identifying the one or more correlations is performed when the signal is received. Optionally, identifying the one or more correlations is performed periodically. Optionally, identifying the one or more offending social interactions is performed when the one or more correlations are identified. Optionally, identifying the one or more offending social interactions is performed periodically. Identifying the one or more correlations, and additionally or alternatively identifying the one or more offending social interactions, when the signal is received facilitates reducing a latency of identifying the one or more social interactions. Identifying the one or more correlation, and additionally or alternatively, identifying the one or more offending social interactions periodically facilitates reducing an amount of computation compared to processing a plurality of other signals for every new signal that is received, thus reducing cost of operation of a system implemented according to the present invention.

In addition, according to some embodiments, the present invention proposes computing a plurality of normalized confidence values using the plurality of entity confidence values of at least some of the plurality of entities. Optionally, each of the plurality of normalized confidence values is a value in an identified range of confidence values, for example a value between 0 and 1. In another example, each of the plurality of normalized confidence values is a value between 0 and 100. Optionally, the identified range of confidence values comprises at least one negative value. Optionally, identifying the one or more offending social interaction is done using the plurality of normalized confidence values. Using a plurality of normalized confidence values facilitates distinguishing between an indication of extreme toxic behavior and an indication of an unpleasant situation.

In addition, according to some embodiments of the present invention identifying the one or more offending social interactions comprises applying a customer specific approval protocol, indicative of a specific definition of offending social interactions of a customer of a system implemented according to the present invention. For example, a pornography web service may approve of adult nudity and prohibit child nudity. The customer specific approval protocol may be applied additionally or alternatively when outputting the indication, for example in order to perform a customer specific managerial action.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

To better understand the present invention, it may be useful to liken the identification of an offending social interaction to assembling a jigsaw puzzle.

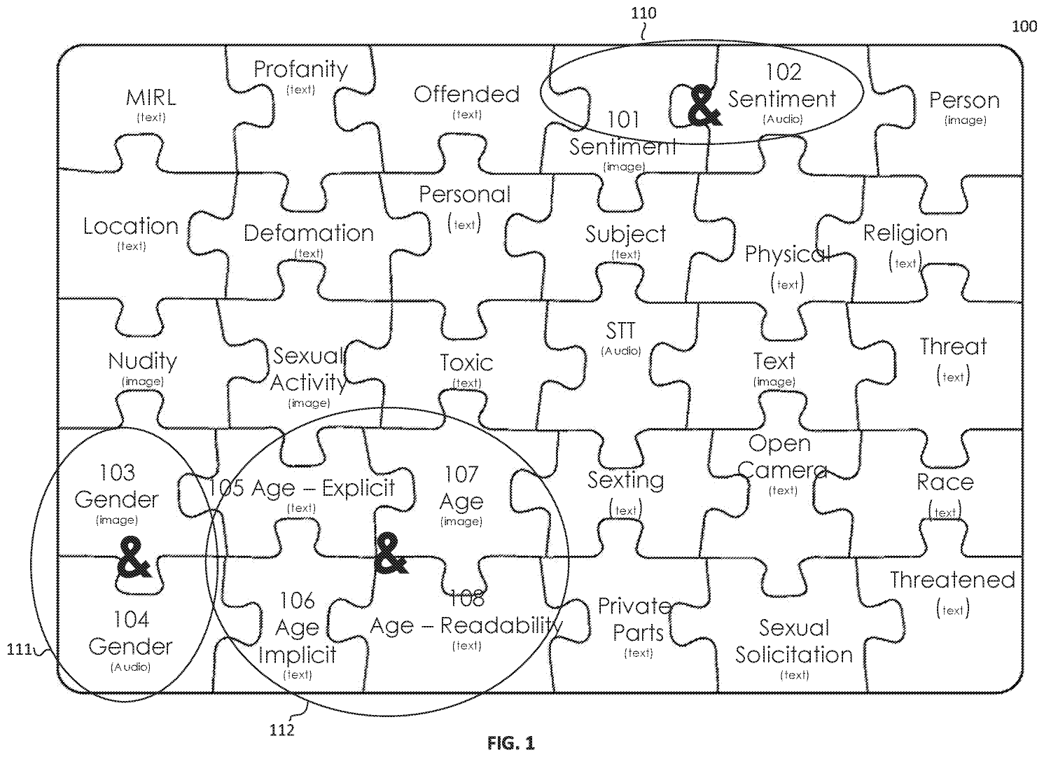

Reference is now made to FIG. 1, showing a schematic illustration 100 likening identification of an offending social interaction to a jigsaw puzzle. According to this analogy, a signal attribute of one of a plurality of signals is likened to a piece of a jigsaw puzzle. Some examples are piece 101 depicting a first sentiment detected in an image signal, and 102 depicting a second sentiment detected in an audio signal. A phenomenon deduced by combining two or more signal attributes may be likened to an areas created by two or more pieces that fit together. Some of the two or more signal attributes may be associated with one signal. Some of the two or more signal attributes may be associated with more than one signal. For example, area 110 depicts a deduction of a sentiment according to the first sentiment and the second sentiment, depicted by piece 101 and piece 102 respectively. Similarly, area 111 depicts a deduction of a gender according to a first gender detected in the image signal, and a second gender detected in the audio signal, depicted by piece 103 and piece 104 respectively. Area 112 depicts a deduction of an age according to a first age mentioned explicitly in a first text signal, a second age implied in a second text signal, a third age detected in an image and a fourth age detected in a third text, depicted by piece 105, piece 106, piece 107 and piece 108 respectively.

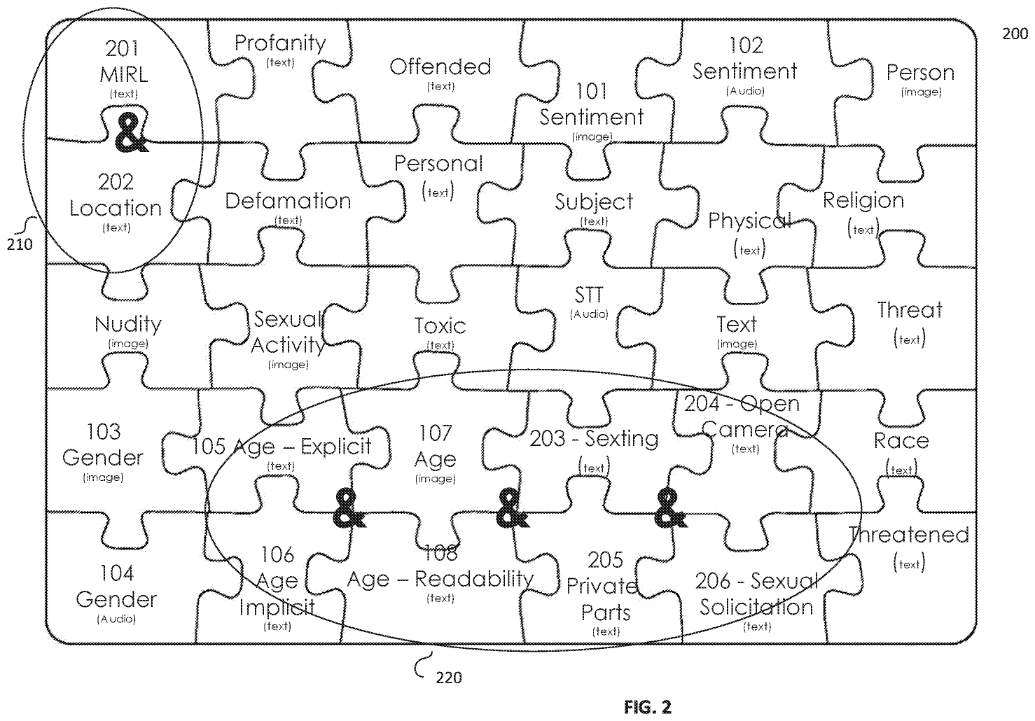

Continuing with this analogy, an offensive social interaction may be identified according to one or more areas of fitting puzzle pieces. Reference is now made also to FIG. 2, showing another schematic illustration 200 likening identification of the offending social interaction to a jigsaw puzzle. According to this example, an invitation to meet in real life, depicted by piece 201, combined with an identification of a location, depicted by piece 202, create area 210 depicting a deduction of a concrete plan to meet in real life. In this example, area 220 may depict a deduction of pedophilia, when a deducted age depicted by area 112 is combined with detection of sexual text depicted by piece 203, detection of a request to open a camera depicted by piece 204, detection of mentioning of private parts in a text signal, depicted by piece 205, and detection of sexual solicitation in another text message depicted by piece 206. A combination of area 210, depicting a deduction of a concrete plan to meet in real life, with area 220, depicting a deduction of pedophilia, may indicate an offending social interaction of a pedophilic predator.

To detect one or more offending social interactions, the present invention proposes in some embodiments thereof implementing the following system.

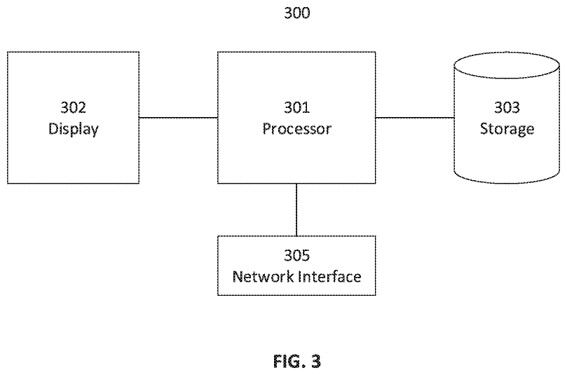

Reference is now made also to FIG. 3, showing a schematic block diagram of an exemplary system 300, according to some embodiments of the present invention. In such embodiments, processing unit 301 is connected to at least one display device 302, optionally for the purpose of outputting an indication of one or more offending social interactions identified by processing unit 301. The processing unit may be any kind of programmable or non-programmable circuitry that is configured to carry out the operations described above. An example of display device is a monitor. The processing unit may comprise hardware as well as software. For example, the processing unit may comprise one or more hardware processors and a transitory or non-transitory memory that carries a program which causes the processing unit to perform the respective operations when the program is executed by the one or more hardware processors. Optionally, processing unit 301 is connected to one or more non-volatile digital storage 303, optionally for the purpose of storing one or more signals and additionally or alternatively a plurality of signal attributes and further additionally or alternatively a plurality of entity confidence values. Some examples of a non-volatile digital storage are a hard disk drive, a non-volatile random access memory (NVRAM), a network connected storage and a storage network. Optionally, processing unit 301 is connected to one or more non-volatile digital storage 303 via one or more digital communication network interface 305. For brevity, henceforth the term “network interface” is used to mean “one or more digital communication network interface”. Optionally, processing unit 303 receives one or more digital signals via network interface 305. Optionally, network interface 305 is connected to a local area network (LAN), some examples being an Ethernet LAN and a Wi-Fi LAN. Optionally, network interface 305 is connected to a wide area network, some examples being a cellular network and the Internet.

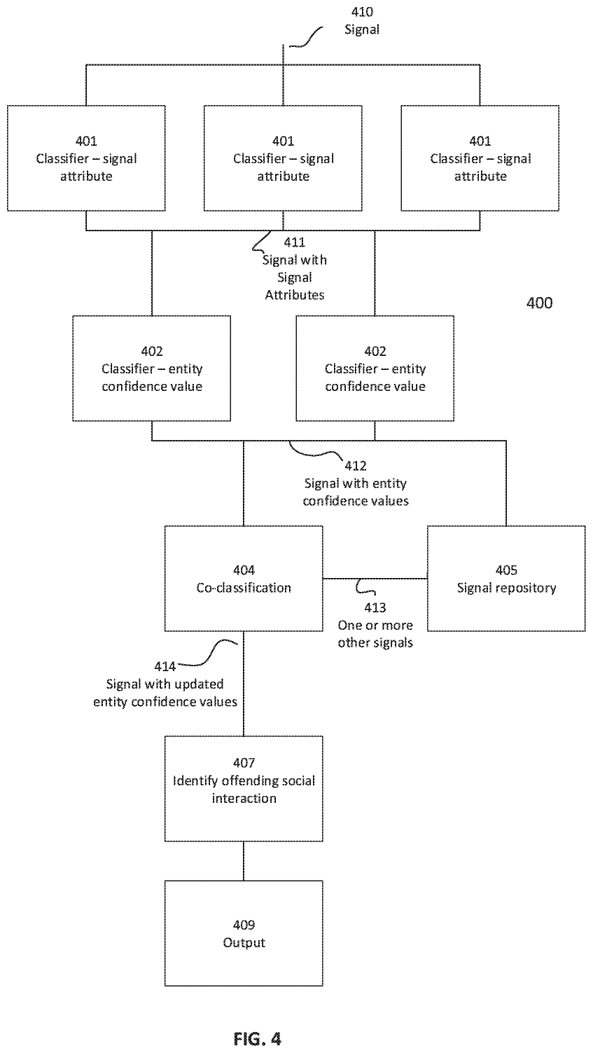

In some embodiments of the present invention, system 300 is adapted to process one or more digital signals according to the following optional flow of data. Reference is now made also to FIG. 4, showing a schematic block diagram of an exemplary flow of data 400, according to some embodiments of the present invention. In such embodiments, signal 410 is processed by one or more classifiers 401 to detect one or more signal attributes. Optionally, the signal with the one or more signal attributes 411 is processed by one or more other classifiers 402 to update one or more entity confidence values of one or more entities associated with signal 410. Optionally, the signal with the one or more entity confidence values 412 is stored in signal repository 405, for example on one or more non-volatile digital storage 303. Optionally, signal repository 405 is a database. Some examples of a database are a relational database, a key-value store, a column-based store, and a document store.

Optionally, the signal with the one or more entity confidence values 412 is input to 404 together with one or more other signals 413 for the purpose of identifying one or more correlations between signal 412 and one or more other signals 413. Optionally, one or more other signals 413 are retrieved from signal repository 405. Optionally, subject to identifying the one or more correlations, one or more of the one or more entity confidence values are further updated according to the one or more correlations. Optionally, the signal with the updated one or more entity confidence values 414 is input to 407 for the purpose of identifying one or more offending social interactions. An example of an offending social interaction is a pedophilic interaction. Optionally, in 409 an indication of the one or more offending social interactions is output, for example by providing the indication to one or more management software objects for the purpose of performing one or more management tasks.

To implement optional data flow 400, in some embodiments of the present invention system 300 implements the following optional method.

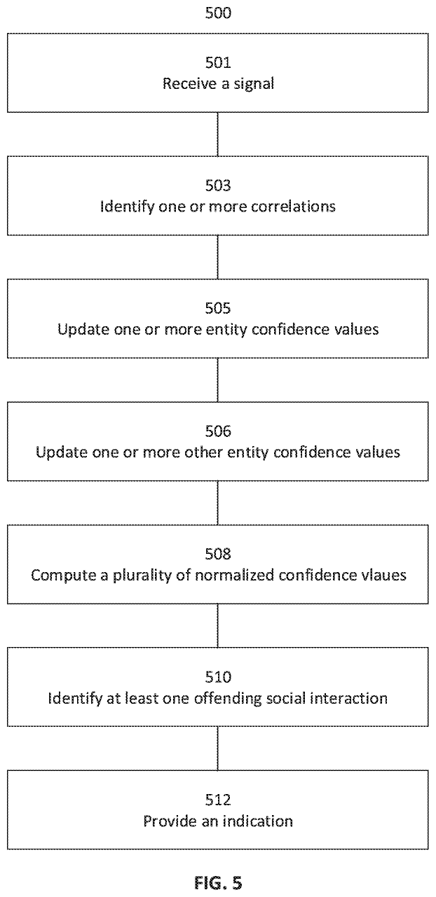

Reference is now made also to FIG. 5, showing a flowchart schematically representing an optional flow of operations 500 for identifying an offending social interaction, according to some embodiments of the present invention. In such embodiments, in 501 processing unit 301 receives a signal from a first other processing unit. Some examples of a signal are a digital video, an image, an image extracted from a video, a text extracted from a video, an audio signal extracted from a video, a text, a captured audio signal, a user location, a user action, and a URL. Optionally, a text extracted from a video comprises one or more subtitles of the video. Optionally, the user action is an event. Some examples of an event are: video uploaded, video watched, video deleted, audio uploaded, audio deleted, user added to a chat, and user removed from a chat.

Optionally, processing unit 301 receives the signal via network interface 305. Optionally, the signal is generated according to an action of a first person. Optionally, the first other processing unit is processing unit 301, for example when the signal is processed by a processing unit of a device used by the first person to engage in a social interaction via a digital platform, for example the first person's smartphone.

Optionally, the signal has a plurality of signal attributes. Optionally, at least some of the plurality of signal attributes are computed by one or more classifiers 401, executed by processing unit 301, in response to the signal. Some examples of a signal attribute are: a user identifier, a signal identifier, an original signal identifier, a chat framework identifier, a chat identifier, a time, an amount of time, a channel identifier, a geographical location, an age, defamation detected, profanity detected, nudity detected, sexual content detected, sexual intention detected, self-harm intention detected, illegal-substance trafficking detected, solicitation detected, insult detected, hunter detected, predator detected, a detected object, a sentiment, person detected, a gender, an age range, a language, a geographic location, a location classification, an amount of associations with a chat, an amount of associations with a location, an amount of warning, a pedophilia score, an aggression score, a real-life invitation, a threat, a grooming score, a reputation, a personal insult score, a racism score, a shaming score, a bullying score, and an offensiveness score. Some examples of a location classification are indoors, outdoors, a school, a mall, and a room. Optionally, a geographic location comprises one or more coordinate values in an identified coordinate system, for example the World Geographic Reference System (GEOREF). A channel may be an identified application, for example WhatsApp or an identified gaming platform. An age may be an explicit age, explicitly detected in the signal. An age may be an implicit age, inferred from one or more features detected in the signal. An age may be an age of a sender of the signal. An age may be an age of a target of the signal. Some examples of a sentiment are anger, disgust, fear, neutral, and sad.

Optionally, the signal is associated with a plurality of entities comprising a first entity and a second entity. Optionally, each entity has a plurality of entity confidence values of a plurality of entity attributes. Some examples of an entity attribute are a pedophilia score, an aggression score, a detection score, a reputation, an aggregation score, a hunter score, a predator score, a grooming score, an insult score, a shaming score, and a racism score. Optionally, the plurality of entity confidence values are computed according to one or more classification outputs of one or more classifiers 401. Optionally, the one or more classification outputs of one or more classifiers 491 are one or more signal attributes. Optionally, the plurality of entity confidence values are computed by one or more other classifiers 402, executed by processing unit 301, in response to input comprising the one or more classification outputs of one or more classifiers 401.

In 503, processing unit 301 optionally identifies one or more correlations between the signal and at least one other signal received from a second other processing unit. When processing unit 301 receives 501 the signal in one of a plurality of iterations, processing unit 301 optionally receives the at least one other signal in at least one other of the plurality of iterations. Optionally, the at least one other signal is generated according to at least one other action of at least one second person. Optionally, the at least one other signal is associated with another plurality of entities comprising the first entity. Optionally, identifying the one or more correlations comprises inputting the signal and the at least one other signal into at least one model. Some examples of a model are a neural network, a machine learning statistical model, an analytical model, and a hybrid machine learning analytical model. Some examples of a neural network are a Long Short-Term Memory (LSTM) model, a bidirectional LSTM (BiLSTM), a Bidirectional Encoder Representations from Transformers (BERT) network, and a convolutional neural network (CNN) such as ResNet50 and Inception V3. Some other examples of a model are a gradient boosting model, an extreme gradient boosting model (xgboost) and a support vector machine (svm).

In 505, processing unit 301 optionally updates one or more entity confidence values of the second entity, subject to identifying the one or more correlations in 503. Optionally, processing unit 301 updates the one or more entity confidence values of the second entity according to an output of the at least one model in 503 in response to input comprising the signal and the at least one other signal. Optionally, the second entity is the first entity, such that one or more entity confidence values of the first entity are updated according to the one or more correlations. Optionally, in 506 processing unit 301 updates, subject to identifying the one or more correlations in 503, one or more other entity confidence values of one or more other entities of the other plurality of entities, i.e. one or more other entities associated with the at least one other signal.

In 510, processing unit 301 optionally identifies one or more offending social interactions by identifying for at least one entity of the plurality of entities one or more other entity confidence values exceeding a threshold entity confidence value. Some examples of an offending social interaction are a pedophilic interaction, a racist interaction, bullying, shaming, and solicitation. Optionally, in 508, processing unit 301 computes a plurality of normalized confidence values using the plurality of entity confidence values of at least some of the plurality of entities. Optionally, each of the plurality of normalized confidence values are in an identified range of confidence values, for example between 0 and 1. Another example of an identified range of confidence values is between 0 and 100. Another example of an identified range of confidence values is between −1 and 1. Optionally, processing unit 301 uses the plurality of normalized confidence values in 510 when identifying the one or more offending social interactions. Optionally, identifying the one or more offending social interactions comprises associating the one or more other signal with the second entity.

In 512, processing unit 301 optionally provides an indication of the one or more offending social interactions, optionally to one or more management software objects executed by processing unit 301, optionally for the purpose of performing one or more management tasks.

Optionally, the indication of the one or more offending social interactions comprises at least one reference to at least one signal associated with the at least one entity having the one or more other entity confidence values exceeding the threshold entity confidence value. Optionally, performing the one or more management tasks comprises sending a message to one or more other processing units connected to processing unit 301 via network interface 305. Optionally, performing the one or more management tasks comprises storing the indication on one or more non-volatile digital storage 303. Optionally, performing the one or more management tasks comprises displaying a message on one or more display 302. Optionally, performing the one or more management tasks comprises instructing the one or more other processing units to decline sending one or more other additional signals associated with the at least one entity. Optionally the one or more other processing unit comprises the first other processing unit and additionally or alternatively the second other processing unit.

Optionally, the one or more other processing units comprises processing unit 301. Optionally, performing the one or more management tasks comprises instructing at least one additional other processing unit to generate an alarm perceivable by a person monitoring an output of the at least one additional other processing unit. Optionally, the one or more additional other processing unit is connected to processing unit 301 via network interface 305. Optionally, the one or more additional other processing unit comprises the first other processing unit and additionally or alternatively the second other processing unit. Optionally, the one or more additional other processing unit comprises processing unit 301. Optionally, the one or more additional other processing unit comprises the one or more other processing unit.

Optionally, processing unit 301 executes one or more of 501, 503, 505, 506, 508, 510 and 512 in one or more of a plurality of iterations.

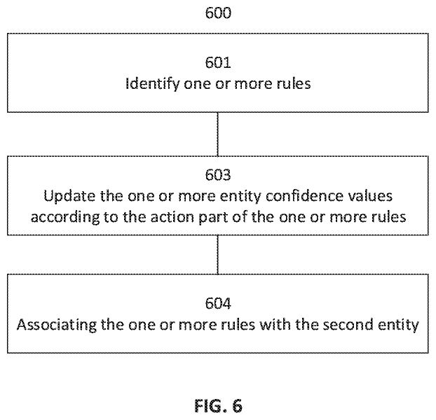

Optionally, identifying the one or more correlations in 503 comprises using one or more rules. Reference is now made also to FIG. 6, showing a flowchart schematically representing an optional flow of operations 600 for identifying an offending social interaction using a rule, according to some embodiments of the present invention. In such embodiments, in 601 processing unit 301 identifies one or more rules of a plurality of rules. Optionally, the one or more rules have a condition part and an action part.

Optionally, processing unit identifies the one or more rules according to a match test applied to the condition part of the one or more rules, a first plurality of confidence values computed for the plurality of signal attributes of the signal, and a second plurality of confidence values computed for at least one other plurality of signal attributes of the at least one other signal. Optionally, the one or more rule applies to more than two signals. When the one or more rules applies to more than two signals, processing unit 301 optionally further applies the match test to at least one additional plurality of confidence values, computed for the plurality of attributes of at least one additional signal. Optionally, each of the at least one additional signals is received from one of a plurality of other hardware processor. Optionally, each of the at least one additional signals is associated with at least one additional plurality of entities, each comprising the first entity. 603 is an optional implementation of 505, when identifying the one or more correlations comprises using one or more rules.

Optionally, in 603 processing unit 301 updates the one or more entity confidence values of the second entity according to the action part of the one or more rules. Optionally, executing 510 comprises executing 604. Optionally in 604 processing unit 301 associates the one or more rules with the second entity. When identifying the one or more correlations comprises using one or more rules the indication of the one or more offending social interactions provided in 512 optionally comprises at least one reference to one or more rules associated with the at least one entity having the one or more other entity confidence values exceeding the threshold entity confidence value.

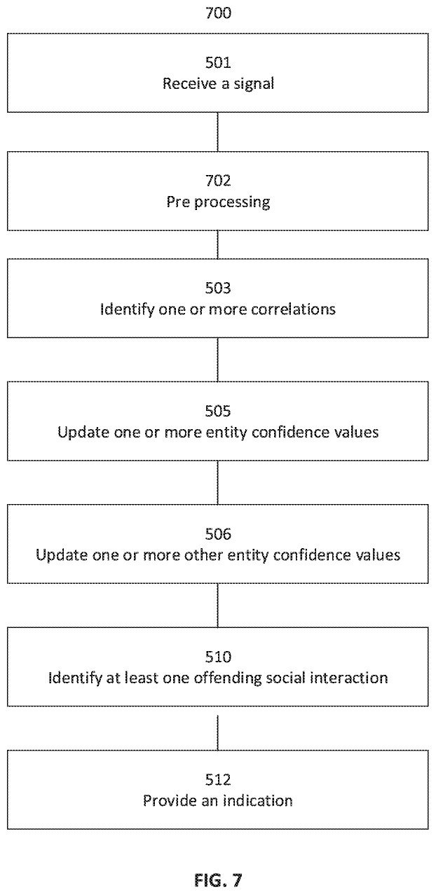

According to some embodiments of the present invention, the signal is pre-processed before computing the plurality of signal attributes. Reference is now made also to FIG. 7, showing a flowchart schematically representing another optional flow of operations 700 for identifying an offending social interaction, according to some embodiments of the present invention. In such embodiments, in 702 the signal is preprocessed, to extract one or more other signals. For example, when the signal is a digital video processing unit 301 optionally extracts a plurality of video frames from the digital video. Optionally, processing unit 301 uses one or more of the plurality of video frames as the signal in 505, 506, 508, 510 and 512. Other examples of an extracted signal are an audio signal extracted from a video signal, a text extracted from a soundtrack of an audio signal, and a text extracted from one or more subtitles of a video signal.

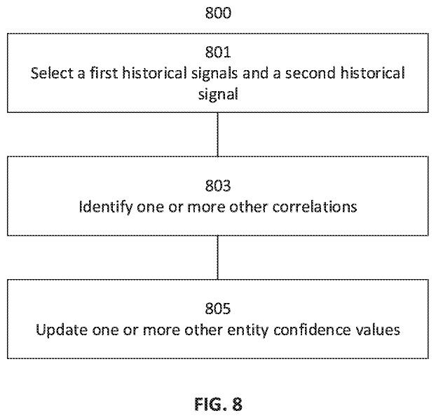

Optionally, processing unit 301 periodically processes one or more historical signals to identify the one or more offending social interactions. Reference is now made also to FIG. 8, showing a flowchart schematically representing an optional flow of operations 800 for periodic processing, according to some embodiments of the present invention. In such embodiments, in 801 processing unit selects in 801 a first historical signal and a second historical signal of a plurality of signals received in a plurality of iterations executed by processing unit 301. Optionally, the first historical signal and the second historical signal are retrieved from one or more non-volatile digital storage 303. Optionally, the first historical signal is associated with a first plurality of entities comprising the first entity. Optionally, the second historical signal is associated with a second plurality of entities comprising the second entity. Optionally, in 803 processing unit 301 identifies at least one other correlation between the first historical signal and the second historical signal. In 805, processing unit 301 optionally updates one or more other entity confidence values of the second entity subject to identifying the one or more other correlations in 803. Optionally, processing unit 301 executes 801, 803 and 805 periodically in a plurality of periodic iterations, in an identified time interval, for example every 30 second. Some other examples of a time interval for period iterations are 1 minute, 10 minutes, 30 minutes, 1 hour, and 24 hours.

According to some embodiments of the present invention, system 300 is a system for identifying an identified offender, for example a pedophile. Other examples of an identified offender include a sexual predator, a drug trafficker, a racist, and a bully. When system 300 is a system for identifying a pedophile, according to some embodiments of the present invention system 300 implements the following optional method.

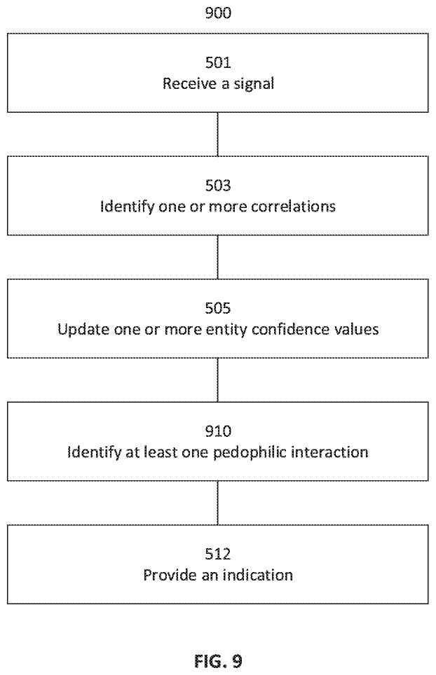

Reference is now made also to FIG. 9, showing a flowchart schematically representing optional flow of operations 900 for identifying a pedophile, according to some embodiments of the present invention. In such embodiments, processing unit 301 executes a plurality of iterations. In one or more of the plurality of iterations, in 501 processing unit 301 receives a signal from a first other hardware. Optionally the signal is generated according to an action of a first person. Optionally the signal has a plurality of signal attributes. Optionally, the signal is associated with a plurality of entities comprising a first entity and a second entity. Optionally, each entity has a plurality of entity confidence value of a plurality of entity attributes. In 503, processing unit 301 optionally identifies one or more correlations between the signal and at least one other signal. Optionally, the at least one other signal is received from at least one other hardware processor in at least one other of the plurality of iterations. Optionally, the at least one other signal is generated according to at least one other action of at least one second person. Optionally, the at least one other signal is associated with another plurality of entities comprising the first entity. In 505, processing unit 301 optionally updated one or more confidence values of the second entity subject to identifying the one or more correlations in 503. Optionally, in 910 processing unit 301 identifies one or more pedophilic interactions by identifying for at least one entity of the plurality of entities at least one other entity confidence value exceeding a threshold entity confidence value. In 512, processing unit 301 optionally provides an indication of the one or more pedophilic interactions to one or more management software objects executed by processing unit 301 for the purpose of performing one or more management tasks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant signal attributes, entity attributes and models will be developed and the scope of the terms “signal attribute”, “entity attribute” and “model” are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for processing digital data signals, comprising at least one hardware processor adapted to identifying an offending social interaction by:
in at least one of a plurality of iterations:
receiving a signal from a first other hardware processor, where the signal is generated according to an action of a first person, has a plurality of signal attributes, and is associated with a plurality of entities comprising a first entity and a second entity, each entity having a plurality of entity confidence values of a plurality of entity attributes;
identifying at least one correlation between the signal and at least one other signal received from at least one second other hardware processor in at least one other of the plurality of iterations, the at least one other signal generated according to at least one other action of at least one second person and associated with another plurality of entities comprising the first entity; and
updating at least one entity confidence value of the second entity subject to identifying the at least one correlation;
identifying at least one offending social interaction by identifying for at least one entity of the plurality of entities at least one other entity confidence value exceeding a threshold entity confidence value; and
providing an indication of the at least one offending social interaction to at least one management software object executed by the at least one hardware processor for the purpose of performing at least one management task.

2. The system of claim 1, wherein the second entity is the first entity.

3. The system of claim 1, wherein the at least one hardware processor is further adapted to updating at least one other entity confidence value of at least one of the other plurality of entities subject to identifying the at least one correlation.

4. The system of claim 1, wherein the plurality of entity confidence values are computed according to at least one classification output of at least one classifier in response to the signal.

5. The system of claim 1, wherein identifying the at least one correlation comprises inputting the signal and the at least one other signal into at least one model; and
wherein updating the at least one entity confidence value of the second entity is according to an output of the at least one model in response to input comprising the signal and the at least one other signal.

6. The system of claim 5, wherein the at least one model is selected from a group of models consisting of: a neural network, a machine learning statistical model, an analytical model, and a hybrid machine learning analytical model.

7. The system of claim 1, wherein the signal is selected from a group of signals consisting of: a digital video, an image, an image extracted from a video, a text extracted from a video, an audio signal extracted from a video, a text, a captured audio signal, a user location, a user action, and a universal resource location (URL) value.

8. The system of claim 7, wherein the user action is selected from a group of events consisting of: video uploaded, video watched, video deleted, audio uploaded, user added to chat, and user removed from chat.

9. The system of claim 1, wherein the signal is a digital video; and
wherein identifying the offending social interaction further comprises:
extracting a plurality of video frames from the digital video; and
using at least one of the plurality of video frames as the signal.

10. The system of claim 1, wherein at least one of the plurality of signal attributes is selected from a group of signal attributes consisting of: a user identifier, a signal identifier, an original signal identifier, a chat framework identifier, a chat identifier, a time, an amount of time, a channel identifier, a geographical location, defamation detected, profanity detected, nudity detected, sexual content detected, sexual intention detected, self-harm intention detected, illegal-substance trafficking detected, solicitation detected, insult detected, hunter detected, predator detected, a detected object, a sentiment, person detected, a gender, an age range, a language, a geographic location, a location classification, an amount of associations with a chat, an amount of associations with a location, an amount of warning, a pedophilia score, an aggression score, a real-life invitation, a threat, a grooming score, a reputation, a personal insult score, a racism score, a shaming score, a bullying score, and an offensiveness score.

11. The system of claim 1, wherein at least one of the plurality of entity attributes is selected from a group of attributes consisting of: a pedophilia score, an aggression score, a detection score, a reputation, an aggregation score, a hunter score, a predator score, a grooming score, an insult score, a shaming score, and a racism score.

12. The system of claim 1, wherein identifying the offending social interaction further comprises associating the other signal with the second entity.

13. The system of claim 12, wherein the indication of the at least one offending social interaction comprises at least one reference to at least one signal associated with the at least one entity.

14. The system of claim 1, wherein identifying the at least one correlation comprises identifying at least one rule of a plurality of rules, the rule having a condition part and an action part, according to a match test applied to the condition part of the at least one rule, a first plurality of confidence values computed for the plurality of signal attributes of the signal, and a second plurality of confidence values computed for at least one other plurality of signal attributes of the at least one other signal; and
wherein updating the at least one entity confidence value of the second entity is according to the action part of the at least one rule.

15. The system of claim 14, wherein the match test is further applied to at least one additional plurality of confidence values, computed for the plurality of attributes of at least one additional signal, where each of the at least one additional signal is received from one of a plurality of other hardware processor, generated according to at least one additional action of at least one additional person, and is associated with at least one additional plurality of entities each comprising the first entity.

16. The system of claim 14, wherein identifying the offending social interaction further comprises associating the at least one rule with the second entity.

17. The system of claim 16, wherein the indication of the at least one offending social interaction comprises at least one reference to at least one rule associated with the at least one entity.

18. The system of claim 1, wherein identifying the offending social interaction further comprises:
in each of a plurality of periodic iterations:
selecting a first historical signal and a second historical signal of a plurality of signals received in the plurality of iterations, the first historical signal associated with a first plurality of entities comprising the first entity and the second entity and the second historical signal associated with a second plurality of entities comprising the first entity;
identifying at least one other correlation between the first historical signal and the second historical signal; and
updating at least one other entity confidence value of the second entity subject to identifying the at least one other correlation.

19. The system of claim 1, wherein the at least one hardware processor is further adapted to computing a plurality of normalized confidence values in an identified range of confidence values using the plurality of entity confidence values of at least some of the plurality of entities; and
using the plurality of normalized confidence values when identifying the at least one offending social interaction.

20. The system of claim 1, wherein the at least one hardware processor is connected to the first other hardware processor via at least one digital communication network interface.

21. The system of claim 1, wherein the at least one hardware processor is the first other hardware processor.

22. The system of claim 1, wherein performing the at least one management task comprises at least one of:
instructing at least one other hardware processor, connected to the at least one hardware processor, to decline sending one or more other additional signals associated with the at least one entity;
instructing at least one additional other hardware processor, connected to the at least one hardware processor, to generate an alarm perceivable by a person monitoring an output of the at least one additional other hardware processor;
sending a message to the at least one other hardware processor;
storing the indication on at least one non-volatile digital storage connected to the at least one hardware processor; and
displaying another message on one or more display devices connected to the at least one hardware processor.

23. A method for processing digital data signals comprising identifying an offending social interaction by:
in at least one of a plurality of iterations:
receiving a signal from a first other hardware processor, where the signal is generated according to an action of a first person, has a plurality of signal attributes, and is associated with a plurality of entities comprising a first entity and a second entity, each entity having a plurality of entity confidence values of a plurality of entity attributes;
identifying at least one correlation between the signal and at least one other signal received from at least one second other hardware processor in at least one other of the plurality of iterations, the at least one other signal generated according to at least one other action of at least one second person and associated with another plurality of entities comprising the first entity; and
updating at least one entity confidence value of the second entity subject to identifying the at least one correlation;
identifying at least one offending social interaction by identifying for at least one entity of the plurality of entities at least one other entity confidence value exceeding a threshold entity confidence value; and
providing an indication of the at least one offending social interaction to at least one management software object executed by the at least one hardware processor for the purpose of performing at least one management task.

24. A system for identifying a suspected pedophile comprising at least one hardware processor adapted for:
in at least one of a plurality of iterations:
receiving a signal from a first other hardware processor, where the signal is generated according to an action of a first person, has a plurality of signal attributes, and is associated with a plurality of entities comprising a first entity and a second entity, each entity having a plurality of entity confidence values of a plurality of entity attributes;
identifying at least one correlation between the signal and at least one other signal received from at least one second other hardware processor in at least one other of the plurality of iterations, the at least one other signal generated according to at least one other action of at least one second person and associated with another plurality of entities comprising the first entity; and
updating at least one entity confidence value of the second entity subject to identifying the at least one correlation;
identifying at least one pedophilic interaction by identifying for at least one entity of the plurality of entities at least one other entity confidence value exceeding a threshold entity confidence value; and
providing an indication of the at least one offending social interaction to at least one management software object executed by the at least one hardware processor for the purpose of performing at least one management task.
